(19) United States
(12) Patent Application Publication
(10) Pub. No.: US 2014/0111500 A1
(43) Pub. Date: Apr. 24, 2014

(54) DISPLAY DEVICE AND COMMUNICATION METHOD

(71) Applicant: Hiroyuki Kasuga, Tokyo (JP)

(72) Inventor: Hiroyuki Kasuga, Tokyo (JP)

(21) Appl. No.: 14/125,046

(22) PCT Filed: Jun. 17, 2011
(86) PCT No.: PCT/JP2011/063909

§ 371 Date: Dec. 9, 2013

(51) Int. Cl. G09G 5/00

(52) U.S. Cl. CPC G09G 5/00
USPC 345/212

(57) ABSTRACT

A display device is used for displaying a video image signal inputted from a signal source which is connected to the display device and is provided outside the display device. The display device includes: a presence sensor which detects whether a person exists within a target range where the display device performs detection; a control unit which changes an operation mode according to a detection result of the presence sensor, and controls a supply amount of electric power supplied to components of the display device according to the changed operation mode; and a communication interface unit which transmits to the signal source, information of the detection result of the presence sensor in a state in which the amount of power supply is controlled by the control unit.

### TECHNICAL FIELD

The present invention relates to a display device that incorporates a presence sensor, and a communication method therefor.

### BACKGROUND ART

Heretofore, a display device is known in which a presence sensor that detects a person (user), is incorporated in a display device such as a television set or a monitor, and has a function of switching the operation mode of the display device itself to normal mode or power saving mode in accordance with detection results of the presence sensor (refer to Patent Document 1).

Furthermore, a system is also known in which a display device incorporating a presence sensor is utilized by being connected to a signal source such as a personal computer (referred to hereunder as “PC”) for example (refer to Patent Document 2). In the display system disclosed in Patent Document 2, in a multiple monitor environment in which a plurality of display devices are connected, an instruction to switch the operation mode of a display device to normal mode or power saving mode is output to other display devices connected in accordance with detection results of a presence sensor incorporated in any one of the display devices. In this display system, a communication means that transmits and receives detection results of a presence sensor, and an instruction to switch the operation mode, is incorporated in each of the PC and display devices.

### PRIOR ART DOCUMENTS

### Patent Documents

[Patent Document 1] Japanese Unexamined Patent Application, First Publication No. 2007-96462

[Patent Document 2] Japanese Unexamined Patent Application, First Publication No. 2010-205054

### SUMMARY OF THE INVENTION

### Problem to be Solved by the Invention

Incidentally, a power saving mode function, which reduces power consumption, is also incorporated in the PC to which the display device is connected. By placing both the display device and the PC in power saving mode, the power consumption of the whole system can be reduced.

However, power saving mode by a presence sensor is a function provided only in the display device. Moreover, in a system in which a display device and a signal source are connected, the display device and signal source are placed in power saving mode independently.

FIG. 4 is a transition diagram showing the transitions of the operation mode of a conventional display device, in a system in which a display device and a signal source are connected. In the following description, each operation will be described on the basis that a conventional display device and a PC are connected.

Normal operation mode is a mode in which a display device performs normal operations in which the display device displays a video image signal. At the time of normal operation mode, a PC user is using the PC in front of (seated at) the display device. Therefore a video image signal is input to the display device continuously, and a presence sensor detects the user's existence. When the user leaves his or her seat in this state, the display device is transitioned from normal operation mode to presence sensor power saving mode (process 1).

Presence sensor power saving mode is an operation mode that reduces the power consumption of the display device by dimming the brightness of the video image signal displayed, or by stopping the display. At the time of presence sensor power saving mode, the PC is not in power saving mode. Therefore a video image signal is input to the display device continuously. However, since the user is away from the front of the display device, the presence sensor is in a state in which the user is not detected. At the time of presence sensor power saving mode, user detection by the presence sensor of the display device continues to be performed. When the user comes back to his or her seat in this state, the presence sensor detects the user's existence, and the display device is transitioned (restored) from presence sensor power saving mode to normal operation mode (process 2).

Moreover, in a state in which the display device is in presence sensor power saving mode, when the PC satisfies the conditions to be in power saving mode, such as a predetermined time having elapsed, the PC enters power saving mode. By so doing, no video image signal is input to the display device from the PC, and the display device is transitioned from presence sensor power saving mode to normal power saving mode (process 3).

Normal power saving mode is an operation mode that stops most of the functions of the display device to thereby reduce the power consumption of a display device. At the time of normal power saving mode, user detection by the presence sensor is also stopped. As a result, even if the user returns to his or her seat in this state, the presence sensor does not detect the user's existence, and the display device is not transitioned from normal power saving mode to another mode. Therefore the user needs to operate the PC, for example by operating a mouse or operating a keyboard connected to the PC, to thereby transition (restore) the PC from power saving mode to normal operation mode. When the PC enters normal operation mode, a video image signal is input to the display device. Therefore the display device is also transitioned (restored) from normal power saving mode to normal operation mode (process 4).

In this manner, in a system in which a conventional display device and a PC are connected, in order to transition (restore) the display device from normal power saving mode to normal operation mode, a video image signal is required to be input to the display device after transitioning (restoring) the PC to normal operation mode. That is, the display device cannot be transitioned (restored) from normal power saving mode to normal operation mode only by the user returning to his or her seat.

Therefore, in the case where the operation mode in the system is transitioned in accordance with the state of whether the user is seated or away from his or her seat, it is necessary to add a structure to the PC whereby the user's state is detected, such as by also installing a presence sensor in the PC. However, a PC is not limited to being installed in front of a user. Therefore even if a presence sensor is installed in the PC, the installed presence sensor may not always be used effectively.

The problem to be solved is to coordinate the power saving mode of a display device and the power saving mode of a signal source connected thereto, by using a presence sensor incorporated in the display device.

### Means for Solving the Problem

In order to solve the above-described problem, display device of the present invention is used for displaying a video image signal inputted from a signal source which is connected to outside, and includes: a presence sensor which detects whether a person exists within a target range where the display device performs detection; a control unit which changes an operation mode according to a detection result of the presence sensor, and controls a supply amount of electric power supplied to components of the display device according to the changed operation mode; and a communication interface unit which transmits to the signal source, information of the detection result of the presence sensor in a state in which the amount of power supply is controlled by the control unit.

Furthermore, the operation mode in the display device of present invention may include a normal operation mode and a power saving mode, the normal operation mode may supply an amount of electrical power required for normal operation by the components of the display device, the power saving mode may supply a minimum amount of electrical power required for operation, to some of the components including the presence sensor and the communication interface unit, to reduce the power consumption of the display device, the control unit may set the operation mode to the power saving mode in a case where the detection result of the presence sensor indicates that no person exists, the control unit may set the operation mode to the normal operation mode in a case where the detection result of the presence sensor indicates that a person exists, and the communication interface unit, during the power saving mode, may transmit to the signal source, the information of the detection result of the presence sensor in a state of a supplied minimum amount of electric power.

Moreover, the communication interface unit in the display device of present invention may transmit, to the signal source, information indicating the detection result of the presence sensor or information indicating that the detection result of the presence sensor has changed when there is a request from the signal source for transmission of the detection result of the presence sensor or when there is an inquiry from the signal source as to whether there is any change in the detection result of the presence sensor.

Furthermore, the communication interface in the display device of present invention may transmit, to the signal source, information indicating the detection result of the presence sensor or information indicating that the detection result of the presence sensor has changed when the presence sensor outputs the detection result or when the presence sensor outputs a different detection result.

Moreover, the communication interface unit in the display device of present invention may transmit, to the signal source, the information indicating the detection result of the presence sensor or the information indicating that the detection result of the presence sensor has changed, using a display data channel/command interface (DDC/CI).

Furthermore, the communication interface unit in the display device of present invention may transmit, to the signal source, the information indicating the detection result of the presence sensor or the information indicating that the detection result of the presence sensor has changed, using a universal serial bus (USB) interface.

In order to solve the above problem, a communication method of the present invention is used for a display device displaying a video image signal inputted from a signal source which is connected to outside, and includes the steps of: detecting, by a presence sensor, whether a person exists within a target range where the display device performs detection; changing, by a control unit, an operation mode according to a detection result of the presence sensor, and controlling a supply amount of electric power supplied to components of the display device according to the changed operation mode; and transmitting, by a communication interface unit, to the signal source, information of the detection result of the presence sensor in a state in which the amount of power supply is controlled by the control unit.

### Effect of the Invention

A display device of the present invention has an advantage in that the power saving mode of a display device and the power saving mode of a signal source connected thereto can be coordinated based on results detected by an incorporated presence sensor.

### BRIEF DESCRIPTION OF THE DRAWINGS

FIG. 1 is a block diagram showing a schematic configuration of a display device according to a first exemplary embodiment of the present invention.

FIG. 2 is a connection diagram showing an example of a connection of the display device and a signal source of the first exemplary embodiment.

FIG. 3 is a block diagram showing a schematic configuration of a display device according to a second exemplary embodiment of the present invention.

FIG. 4 is a transition diagram showing transitions of the operation mode of a conventional display device in a system in which a display device and a signal source are connected.

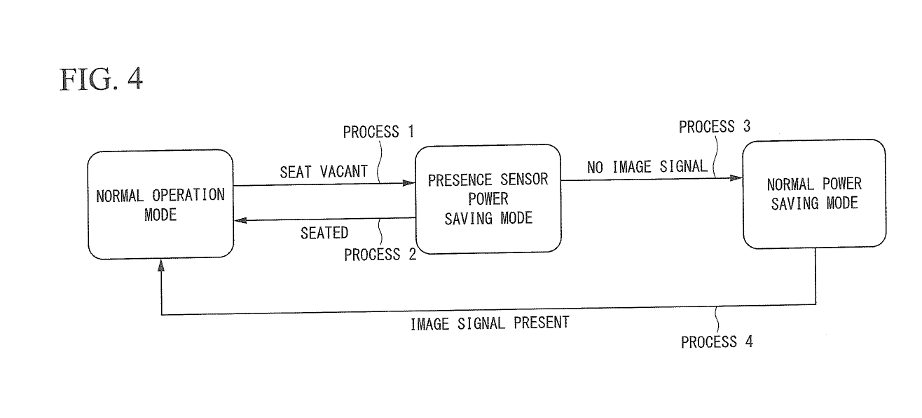

### EMBODIMENTS FOR CARRYING OUT THE INVENTION

### First Exemplary Embodiment

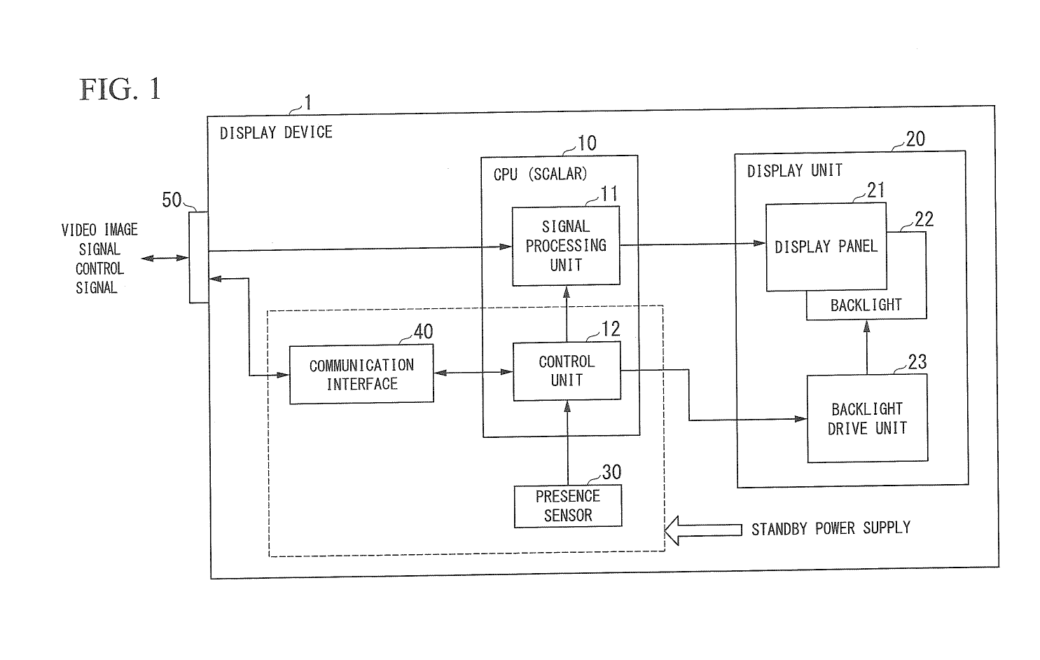

Hereunder is a description of exemplary embodiments of the present invention with reference to the drawings. FIG. 1 is a block diagram showing a schematic configuration of a display device according to a first exemplary embodiment. FIG. 1 shows an example of a case in which the display device of the first exemplary embodiment is a liquid crystal display (LCD). In FIG. 1, a display device 1 includes a CPU 10, a display unit 20, a presence sensor 30, a communication interface 40, and a video image/control signal terminal 50.

The display device 1 is a display device that uses a display data channel/command interface (DDC/CI) as a communication interface, and can communicate with a signal source using DDC/CI protocol. Accordingly, in addition to input of a video image signal output from the signal source, a control signal (transmission and reception signal) for performing communication with the signal source, is connected to the video image/control signal terminal 50 of the display device 1.

The CPU 10 controls the whole of the display device 1. The CPU 10 includes a signal processing unit 11 and a control unit 12. The signal processing unit 11 performs a range of signal processing to display the video image signal input from the signal source via the video image/control signal terminal 50. Then the signal processing unit 11 outputs a video image signal after signal processing to the display unit 20. The control unit 12 controls the operation of each of the components in the display device 1 including the signal processing unit 11. By this control of the signal processing unit 11, for example the operation of each of the components of the display device 1 in power saving mode is controlled.

The display unit 20 displays the video signal which is input from the signal processing unit 11, after signal processing. The display unit 20 includes a display panel 21, a backlight 22, and a backlight drive unit 23. The display panel 21 is a liquid crystal panel that displays an image according to an input video image signal. The backlight 22 radiates a transmitted light to the back of the display panel 21. For example, the backlight 22 is a light source formed from light emitting diodes (LED). The backlight drive unit 23 drives the backlight 22 in accordance with control by the control unit 12 inside the CPU 10. By the drive of the backlight 22 by the backlight drive unit 23, the brightness of the transmitted light emitted by the backlight 22 is controlled. In the display device 1, by the control unit 12 controlling the backlight drive unit 23, the brightness of the transmitted light emitted by the backlight 22 is changed, and the brightness of the image displayed on the display panel 21 is adjusted. For example, in the case where the display device 1 is in power saving mode, the control unit 12 instructs the backlight drive unit 23 to turn off the backlight 22, and the backlight drive unit 23 turns off the backlight 22, to thereby reduce the power consumption of the display device 1.

The presence sensor 30 detects a person in a predetermined range (detection range) in front of the display device 1. The presence sensor 30 outputs information of the person detected (referred to hereunder as “human detection information”), to the control unit 12 of the CPU 10. The human detection information output by the presence sensor 30 includes information indicating whether or not a person exists in the detection range, information indicating the location in the detection range, for example where the distance of the detection range is 100%, the percentage of the location at which the person exists, and so forth. Regarding the determination of whether or not a person exists in the detection range, the construction may be such that a predetermined threshold value (detection range) is set in the control unit 12, and the control unit 12 determines whether or not a person exists in the detection range based on the human detection information input from the presence sensor 30.

The communication interface 40 communicates with a signal source via the video image/control signal terminal 50. In the display device 1, by the DDC/CI protocol, a region of the communication data for the signal source to acquire human detection information detected by the presence sensor 30 (for example, a user defined region of the DDC/CI protocol) is shared between the signal source and the display device 1 in advance. When human detection information is requested from the signal source, the communication interface 40 transmits the human detection information input via the control unit 12, to the signal source via the video image/control signal terminal 50.

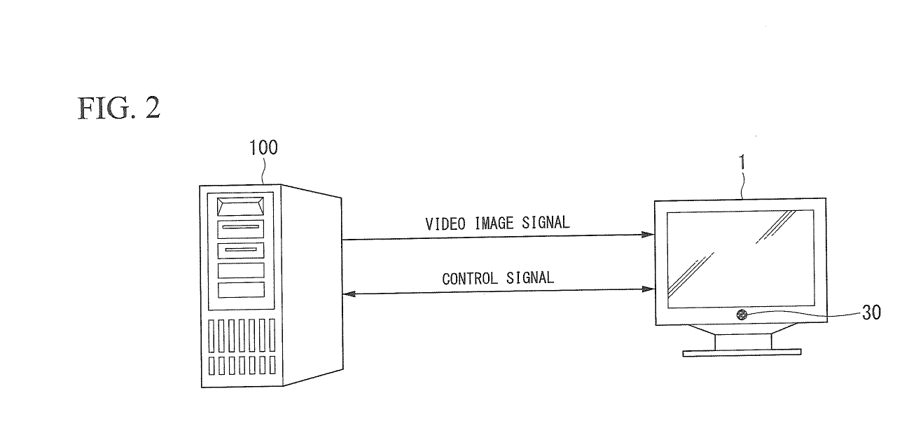

Next is a description of the connection between the display device 1 and the signal source with reference to FIG. 2, in order to describe the operation when the display device 1 is in power saving mode. FIG. 2 is a connection diagram showing an example of the connection between the signal source and display device 1 of the first exemplary embodiment. FIG. 2 shows an example of a case where a personal computer 100 (referred to hereunder as “PC 100”) is connected as a signal source. The operation at the time of power saving mode in the display device 1, is described with reference to the block diagram of the display device 1 shown in FIG. 1.

As shown in FIG. 2, in the display device 1 and the PC 100, a video image signal and a control signal are connected via a video image/control signal terminal (in the case of the display device 1, it is the video image/control signal terminal 50) of a DDI/CI interface provided in each.

The display device 1 and the PC 100 perform communication of human detection information detected by the presence sensor 30 disposed in the front of the display device 1, by a control signal of the DDI/CI interface contained in the video image/control signal terminal 50. In the communication by the DDC/CI protocol, communication commands cannot be transmitted from the display device which is on the slave side. Therefore by responding to commands requesting human detection information transmitted from the PC 100 which is on the master side, human detection information detected by the presence sensor 30 is transmitted from the display device 1 to the PC 100. Accordingly, the PC 100 requests human detection information periodically at a predetermined time interval (for example, one minute). Instead of the PC 100 requesting human detection information, the PC 100 may inquire whether or not there is a change in the human detection information.

When the display device 1 detects by the presence sensor 30 that a person does not exist, the control unit 12 turns off a main power supply to thereby transition the operation of the display device 1 to power saving mode. Furthermore, the display device 1, in response to a request for human detection information received after detecting that a person does not exist by the presence sensor 30, transmits human detection information indicating that a person does not exist, to the PC 100. The PC 100 receives human detection information indicating that a person does not exist, and thereby the PC 100 itself can also be transitioned to power saving mode, so that the output of a video image signal can be stopped.

In the power saving mode of the display device 1, the operations of each of the components in the display device I are the minimum required. To be more specific, for example, the control unit 12 disconnects, from the control unit 12, all of the input and output ports excluding an input and output unit which detects the pressing of buttons on the main body (not shown in the figure) provided in the display device 1, and commands received optically by a light receiving unit of a remote control (not shown in the figure);

the presence sensor 30; and the communication interface 40. By so doing, the operation of the components in the display device 1 that are disconnected is stopped. Moreover, the control unit 12 switches each of the components operating during power saving mode, to operation with a standby power supply, that is, operation with the minimum required power supply during power saving mode. In a state in which standby power supply is supplied, the presence sensor 30 and the communication interface 40 detect whether or not a person exists, and communicate with the PC 100.

Furthermore, the control unit 12 reduces the operation clock of the control unit 12 itself to the minimum operation clock by which pressing buttons, detecting commands, obtaining human detection information detected by the presence sensor 30, and communicating by the communication interface 40 can be performed. By so doing, the control unit 12 reduces the power consumption of the display device 1 at the time of power saving mode.

Moreover, the PC 100 requests human detection information regularly at a predetermined time interval, even during power saving mode. Then when the display device 1 detects by the presence sensor 30 that a person exists, the control unit 12 turns the main power supply on to restore the operation of the display device 1 to normal operation mode. Furthermore, the display device 1 transmits human detection information indicating that a person exists, to the PC 100 in response to a request for human detection information received after detecting that a person exists by the presence sensor 30. By the PC 100 receiving human detection information indicating that a person exists, the PC 100 itself can be restored from power saving mode to normal operation mode, so that it is possible to start the output of a video image signal.

As described above, according to the display device 1 of the first exemplary embodiment, it is possible to transmit human detection information detected by the presence sensor 30, to the signal source regardless of the operation mode of the display device 1. As a result, in a system of the first exemplary embodiment in which the display device 1 and the signal source are connected, the signal source can change the operation mode of the signal source itself based on the human detection information detected by the presence sensor 30.

### Second Exemplary Embodiment

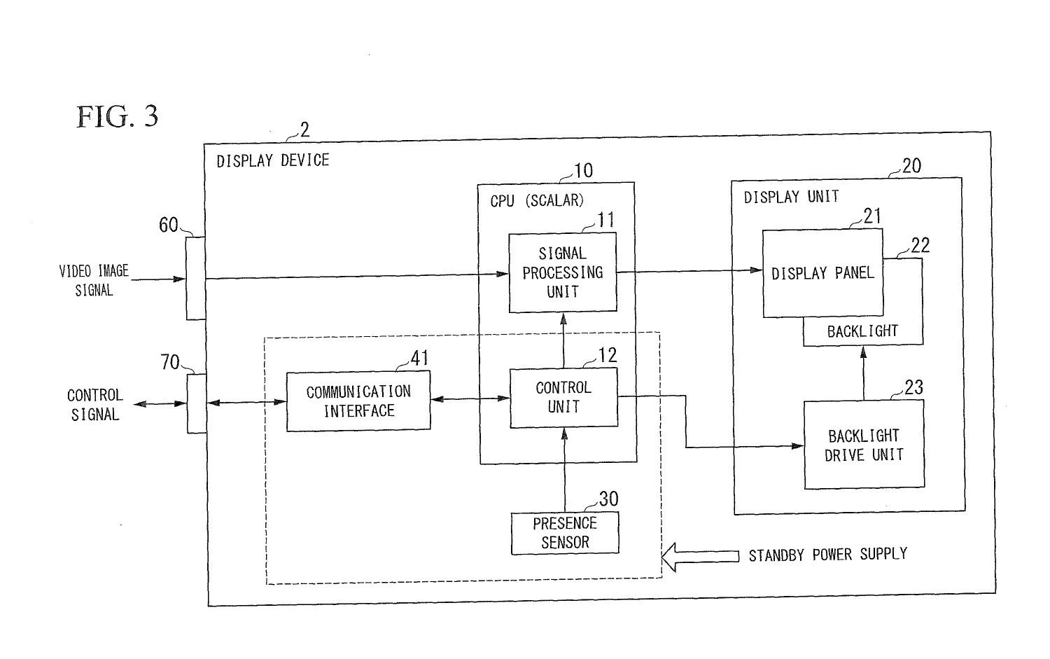

Next is a description of a display device of a second exemplary embodiment of the present invention. FIG. 3 is a block diagram showing a schematic configuration of a display device according to the second exemplary embodiment of the present invention. FIG. 3 shows an example of a case of a liquid crystal display similar to the display device 1 of the first exemplary embodiment shown in FIG. 1. In FIG. 3, a display device 2 includes a CPU 10, a display unit 20, a presence sensor 30, a communication interface 41, a video image signal terminal 60, and a control signal terminal 70.

The display device 2 of the second exemplary embodiment has a construction in which the video image/control signal terminal 50 of the display device 1 of the first exemplary embodiment shown in FIG. 1 is divided into the video image signal terminal 60 and the control signal terminal 70. Furthermore, accompanying this difference in the construction, the construction includes the communication interface 41 instead of the communication interface 40 in the display device 1. The other components are the same as the components in the display device 1. Therefore, the same reference symbols are used for the same components as those in the display device 1 of the first exemplary embodiment shown in FIG. 1, and the detailed descriptions thereof are omitted.

The display device 2 displays on the display unit 20, a video image signal input from a signal source via the video image signal terminal 60. Furthermore, the display device 2 performs communication with the signal source, of human detection information detected by the presence sensor 30, in accordance with the communication protocol of a control signal connected to the signal source via the control signal terminal 70. In the following description, a case is used as an example in which the communication protocol of a control signal connected to the control signal terminal 70 is a universal serial bus (USB).

The communication interface 41 communicates with the signal source via the control signal terminal 70. In the display device 2, the communication mode (for example, low speed mode) for the signal source to acquire human detection information detected by the presence sensor 30 is determined between the signal source and the display device 2 in advance using the USB. After a USB connection is established, each time there is a change in the human detection information input via the control unit 12, that is, each time the presence sensor 30 outputs different human detection information to the control unit 12, the communication interface 41 transmits the changed human detection information via the control signal terminal 70 to the signal source.

Next is a description of the operation at the time of power saving mode in the display device 2. In the following description, it is supposed that the PC 100 shown in FIG. 2 is connected as a signal source of the display device 2. Regarding connection between the display device 2 and the PC 100, the connection diagram is similar to that of FIG. 2 except that the video image/control signal terminal 50 of the display device 1 is divided into the video image signal terminal 60 and the control signal terminal 70. Therefore an illustration of the connection of the display device 2 and the PC 100 is omitted. Moreover, the operation at the time of power saving mode in the display device 2 is described with reference to the block diagram of the display device 2 shown in FIG. 3.

A video image signal is connected to the display device 2 and the PC 100 via a video image signal terminal (in the case of the display device 2, it is the video image signal terminal 60) provided in each. Moreover, a control signal is connected via a USB control signal terminal (in the case of the display device 2, it is the control signal terminal 70) provided in each.

The display device 2 outputs to the PC 100, a change in the human detection information detected by the presence sensor 30 disposed in the front of the display device 2, using the USB. Using the USB, a change in the human detection information can be continuously transmitted to the PC 100 from the display device 2. Instead of the display device 2 transmitting a change in the human detection information, the display device 2 may continuously transmit human detection information to the PC 100.

When the display device 2 detects by the presence sensor 30, that a person does not exist, similarly to the display device 1 of the first exemplary embodiment, the control unit 12 turns off the main power supply to thereby transition the operation of the display device 2 to power saving mode. Furthermore, the display device 2 transmits, to the PC 100, a change in the human detection information indicating that the human detection information detected by the presence sensor 30 has changed from a state in which a person exists to a state in which a person does not exist. The PC 100 receives the change in the human detection information indicating the change from a state in which a person exists to a state in which a person does not exist, and thereby the PC 100 itself can also be transitioned to power saving mode, so that the output of a video image signal can be stopped.

In power saving mode in the display device 2, similarly to the display device 1 of the first exemplary embodiment, the operations of each of the components in the display device 2 are the minimum required. Accordingly, during power saving mode, the presence sensor 30 and the communication interface 41 operate by a standby power supply. Furthermore, the operation clock of the control unit 12 is reduced to the minimum operation clock by which pressing buttons, detecting commands, obtaining human detection information detected by the presence sensor 30, and USB communication by the communication interface 41 can be performed. By so doing, the control unit 12 reduces the power consumption of the display device 2 at the time of power saving mode.

Moreover, even during power saving mode, the PC 100 receives human detection information by the USB. This state is similar to the state in which the PC 100 receives operations with respect to the PC, such as by a connected mouse or keyboard, for example.

When the display device 2 detects by the presence sensor 30 that a person exists, similarly to the display device 1 of the first exemplary embodiment, the control unit 12 turns the main power supply on, and restores the operation of the display device 2 to normal operation mode. Furthermore, the display device 2 transmits to the PC 100, a change in the human detection information indicating that the human detection information detected by the presence sensor 30 has changed from a state in which a person does not exist to a state in which a person exists. By the PC 100 receiving the change in the human detection information indicating the change from a state in which a person does not exist to a state in which a person does exist, the PC 100 itself can also he transitioned from power saving mode to normal operation mode, so that it is possible to start the output of a video image signal.

As described above, according to the display device 2 of the second exemplary embodiment, it is possible to transmit a change in human detection information detected by the presence sensor 30, to the signal source regardless of the operation mode of the display device 2. As a result, in a system of the second exemplary embodiment in which the display device 2 and the signal source are connected, the signal source can change the operation mode of the signal source itself based on the human detection information detected by the presence sensor 30.

As described above, according to the exemplary embodiments of the present invention, it is possible to transmit detection information of a presence sensor to a signal source, regardless of the operation mode of the display device. As a result, in a case where a system in which the signal source and the display device of the present invention are connected, using a presence sensor incorporated in the display device, it is possible to coordinate the power saving mode of the display device and the power saving mode of the connected signal source.

In the exemplary embodiments, a case is described in which the display device is a liquid crystal display. However, the exemplary embodiments of the present invention are not limiting. Other display systems may be used for the display system of the display device. For example, an organic EL (Electro Luminescent) display or a plasma display panel (PDP) can also be used. In this case, for example the control of normal operation mode and power saving mode in the control unit 12 are changed appropriately according to the display system of the display device.

Furthermore, in the exemplary embodiments, a case is described in which the communication protocol of the display device is DDC/CI protocol or USB. However, the method of communication of the detection information of the presence sensor is not limited to the exemplary embodiments. For example, provided that it is a method in which the detection information of the presence sensor can be transmitted each time there is a request for the detected information from the signal source, or an inquiry of whether or not there is a change in the detected information from the signal source, a range of communication methods can be used. Moreover, a method in which the display device can transmit the detected information of the presence sensor periodically or each time there is a change in the detected information, a range of communication methods can be used.

Furthermore, in the exemplary embodiments, a case is described in which the signal source is a personal computer. However, the signal source connected to the display device is not limited to the exemplary embodiments of the present invention. For example, the signal source may be a player for reproducing images. In this case also, in a system in which a display device and a player are connected, if a method of communicating detected information of the presence sensor is shared, it is similarly possible to coordinate the power saving mode of the display device and the power saving mode of the connected signal source.

As above, the exemplary embodiments of the present invention are described with reference to the drawings. However, specific constructions are not limited to the exemplary embodiments, and a range of design changes or the like are also included provided they do not depart from the scope of the invention.

### INDUSTRIAL APPLICABILITY

A display device of the present invention, by being connected to a signal source, can be applied for a system in which the power saving modes of the display device and the signal source are coordinated.

### REFERENCE SYMBOLS

1, 2 Display device
10 CPU
11 Signal processing unit
12 Control unit
20 Display unit
21 Display panel
22 Backlight
23 Backlight drive unit
30 Presence sensor
40, 41 Communication interface
50 Video image/control signal terminal
60 Video image signal terminal
70 Control signal terminal
100 Personal computer

1. A display device for displaying a video image signal inputted from a signal source which is connected to the display device and is positioned outside the display device, the display device comprising:
a presence sensor which detects whether a person exists within a target range where the display device performs detection;
a control unit which changes an operation mode according to a detection result of the presence sensor, and controls a supply amount of electric power supplied to components of the display device according to the changed operation mode; and
a communication interface unit which transmits to the signal source, information of the detection result of the presence sensor in a state in which the amount of power supply is controlled by the control unit.

2. The display device according to claim 1,
wherein the operation mode includes a normal operation mode and a power saving mode,
in the normal operation mode, the control unit performs control so that an amount of electrical power required for normal operation by the components of the display device is to the components of the display device,
in the power saving mode, the control unit performs control so that a minimum amount of electrical power required for operation is supplied to some of the components including the presence sensor and the communication interface unit, to reduce the power consumption of the display device,
the control unit sets the operation mode to the power saving mode in a case where the detection result of the presence sensor indicates that no person exists,
the control unit sets the operation mode to the normal operation mode in a case where the detection result of the presence sensor indicates that a person exists, and
the communication interface unit, during the power saving mode, transmits to the signal source, the information of the detection result of the presence sensor in a state of the minimum amount of electric power being supplied to the communication interface unit.

3. The display device according to claim 2, wherein the communication interface unit transmits, to the signal source, information indicating the detection result of the presence sensor or information indicating that the detection result of the presence sensor has changed when the communication interface receives a request from the signal source for transmission of the detection result of the presence sensor or when the communication interface receives an inquiry from the signal source as to whether there is any change in the detection result of the presence sensor.

4. The display device according to claim 2, wherein the communication interface transmits, to the signal source, information indicating the detection result of the presence sensor or information indicating that the detection result of the presence sensor has changed when the presence sensor outputs the detection result or when the presence sensor outputs a different detection result.

5. The display device according to claim 3, wherein the communication interface unit transmits, to the signal source, the information indicating the detection result of the presence sensor or the information indicating that the detection result of the presence sensor has changed, using a display data channel/command interface (DDC/CI).

6. The display device according to claim 4, wherein the communication interface unit transmits, to the signal source, the information indicating the detection result of the presence sensor or the information indicating that the detection result of the presence sensor has changed, using a universal serial bus (USB) interface.

7. A communication method for a display device displaying a video image signal inputted from a signal source which is connected to the display device and is provided outside the display device, the communication method comprising:
detecting whether a person exists within a target range where the display device performs detection to obtain a detection result;
changing an operation mode according to the detection result, and controlling a supply amount of electric power supplied to components of the display device according to the changed operation mode; and
transmitting, to the signal source, information of the detection result in a state in which the amount of power supply is controlled.
